(19) United States
(12) Patent Application Publication
(10) Pub. No.: US 2008/0268755 A1
(43) Pub. Date: Oct. 30, 2008

(54) Motorized Tool and Support Table Therefore

(76) Inventor: Mark G. Dreyer, Aurora, IL (US)

Correspondence Address: MCCRACKEN & FRANK LLP, 311 S. WACKER DRIVE, SUITE 2500, CHICAGO, IL, 60606, US

(21) Appl. No.: 11/427,255

(22) Filed: Jan. 25, 2008

Related U.S. Application Data
(60) Provisional application No. 60/695,373, filed on Jun. 30, 2005.

(51) Int. Cl. B24B 23/04; B24B 41/00; B25H 1/00

(52) U.S. Cl. 451/163; 451/356; 451/344; 451/411; 451/461

(57) ABSTRACT

A motorized tool, such as an oscillating spindle sander, includes a drive unit that is removably carried by a support table such that a motor of the drive unit is disposed below a tabletop and a tool attachment is disposed above the tabletop. The drive unit is readily removable from the table so that another drive unit having a similar shape and a different tool attachment may be used with the table.

### CROSS REFERENCE TO RELATED APPLICATIONS

This application claims the benefit of U.S. Provisional Application Ser. No. 60/695,373, filed Jun. 30, 2005, and is hereby incorporated herein by reference in its entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to motorized machine tools and related accoutrements.

2. Description of the Background of the Invention

A variety of motorized power tools are on the market to perform numerous tasks. Most tools are developed to do a single task, such as a sander, router, and numerous saws (miter, table, scroll, reciprocating, etc.). Each tool has a different physical shape, or form factor, as well as sets of peripherals and accessories that make each tool more precise, powerful, or versatile. With each modification, each of these tools becomes more desirable in terms of convenience and space. Unfortunately for a consumer, accessories and add-ons frequently are not properly or safely usable with more than one tool because each tool has a different form factor for which the accessories are specially adapted.

For many small workshops, physical space and versatility of a tool are significant factors in purchasing equipment. In recent years, there has been some effort by tool manufacturers to address these needs by producing tools that can be used for different purposes. For example, some table saws now incorporate side tables that are modified for use as a router table. In another example, a sanding sleeve may be used with a drill press such that the drill press may also be used as a spindle sander. One tool that includes significant upgrades and accessories to have added utility is a router, which is frequently used to cut or form wood to a desired shape, size, or profile. The router is often mounted under a table or other supporting surface to stabilize the work piece as it passes a bit. In this configuration, a guide fence may be used to guide the piece of wood as it passes by the bit. Additionally, lift assemblies or kits for use with a router and table, such shown in FIG. 1 or disclosed in Fontaine U.S. Pat. No. 6,792,984, which is incorporated herein by reference in its entirety, allow for very precise vertical adjustment of the router relative to the table. These fence and lift assembly accessories have numerous advantages and usefulness that make them very helpful for performing some woodworking tasks. Unfortunately, these accessories are limited to being properly and safely used with only the router.

Another useful woodworking tool is an oscillating spindle sander. A typical bench top spindle sander, such as shown in FIG. 2, includes a free standing body having a support frame disposed underneath a working plane, a motor carried by the body underneath the working plane, and a sanding tool connected to the motor and extending above the working plane. The motor is permanently mounted to the body, which is often steel or plastic. The body is, in turn, is designed to be permanently mounted to a work bench or similar support with mounting screws or bolts in order to keep the spindle sander immobile during use. The sanding tool includes a spindle driven by the motor, a sleeve disposed on the spindle, and sandpaper disposed on the sleeve. To change the size of the spindle or grit of the sandpaper, a nut is removed from the top of the spindle, the sleeve is removed, and a different sleeve is attached or, alternatively, the same sleeve is re-attached carrying different grit sandpaper. For each sleeve, a different insert sleeve can be mounted to allow for tighter movement of the work piece to the sanding sleeve itself. Unfortunately, the spindle sander cannot be mounted in the lift assembly of FIG. 1 for interchangeable use in a support table, and the spindle sander does not include any accessories for better controlling a work piece and takes up a large amount of additional space in a small workshop. Additionally, because some or most of the work pieces do not engage the entire surface of the sandpaper, only a portion of the sandpaper is completely used, which often results in a usable portion of the sandpaper being wasted.

### SUMMARY OF THE INVENTION

In one aspect of the invention, an oscillating spindle sander includes a body having a form factor and a work attachment. The form factor of the body is the same as a form factor of a portable router body that is adapted to be removably received in a harness carried by a work table.

In another aspect of the invention, a motorized tool kit includes a first portable motorized tool having a first function and a body having a form factor, a second portable motorized tool having a second function different from the first function and a second body having the same form factor, and a table comprising a harness below a table top. The bodies of the first portable motorized tool and the second portable motorized tool are alternatingly releasably operatively mountable within the harness with a work attachment positioned to engage a work piece disposed on top of the table top.

In a further aspect of the invention, a support table includes a harness that is adapted to alternatingly receive an oscillating spindle sander drive unit and a second tool drive unit. The oscillating spindle sander drive unit has a form factor and the second tool drive unit has the same form factor. Each drive unit includes a work attachment driven by a motor. The work attachment is disposed substantially above a working surface of the table and the motor is disposed substantially below the working surface when the respective drive unit is operatively received in the harness.

Other aspects will be apparent to those skilled in the art from the following detailed description, in which:

### BRIEF DESCRIPTION OF THE DRAWINGS

FIG. 1 is a perspective view of a router lift assembly;

FIG. 2 is a perspective view of a typical bench top spindle sander; and

FIG. 3 is an exploded isometric view of an oscillating spindle sander according to one aspect.

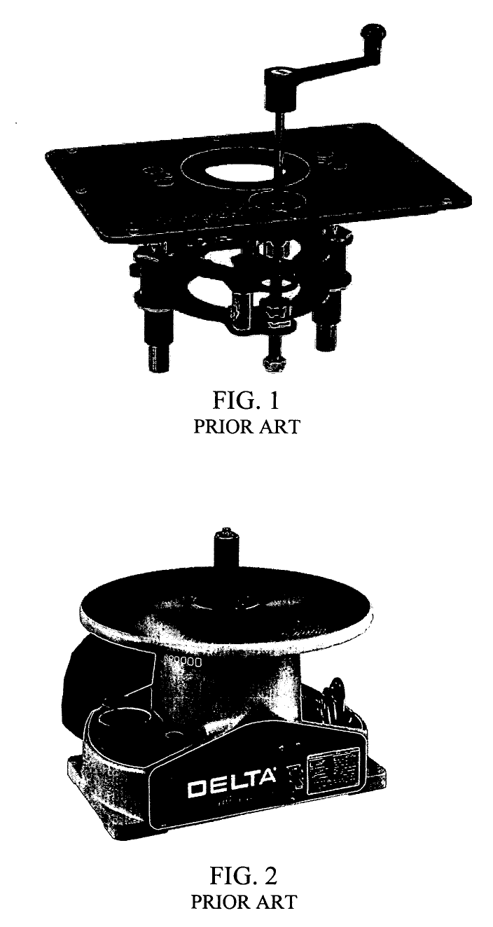

### DETAILED DESCRIPTION OF THE PREFERRED EMBODIMENTS

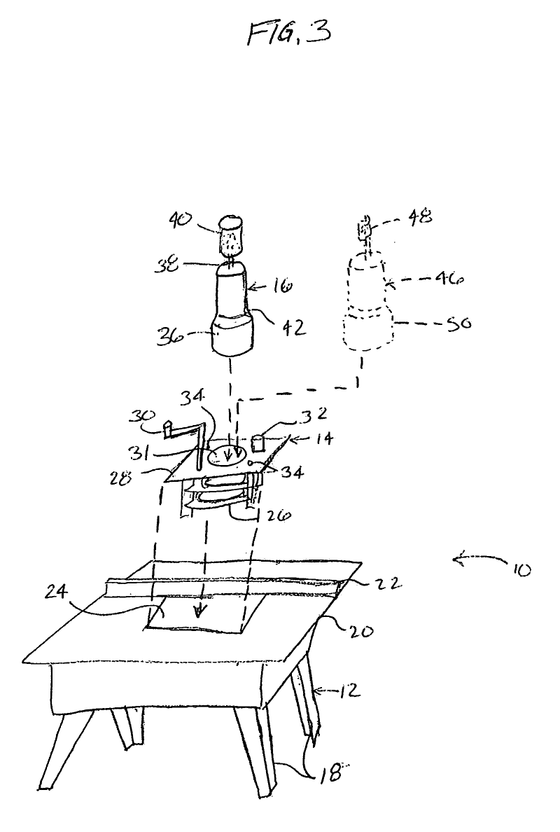

Turning now to FIG. 3, a motorized tool, such as a portable hand held oscillating spindle sander 10, according to one embodiment includes a support structure, such as a table 12 and a lift assembly 14, and a drive unit 16. The table includes legs 18 extending downwardly from a tabletop 20. A work piece guide, such as a rail or fence 22, for guiding a work piece (not shown) is disposed on an upper surface of a tabletop 20 adjacent to an opening 24 through the tabletop that accepts the lift assembly 14 therein.

The lift assembly 14 includes a harness 26 shiftably extended downwardly from a top plate 28 and an adjustment mechanism, such as a worm gear attached to a handle 30, for shifting the harness toward and away from the top plate. The harness 26 is adapted to receive and releasably hold the drive unit 16 therein through an opening 31 through the top plate 28. The lift assembly 14 removably seats in the opening 24 and is carried by the table such that the tabletop 20 is coextensive with the top plate 28 to provide a smooth working surface thereon. Another work piece guide, such as a pin 32, protrudes upwardly from a hole in the top plate 28 and may be moved and fitted into yet other holes 34 located in the top plate to provide different guide locations. Generally, although not necessarily, the pin 32 is used only when the fence 22 is not being used.

The drive unit 16 includes a motor 36, which drives a shaft 38, and a sanding attachment 40 disposed on the shaft. In one embodiment, the sanding attachment is a generally cylindrical sanding drum, which is rotated by the shaft 38 when the motor 36 is turned on. In another embodiment, the sanding attachment 40 includes a spindle and sleeve covered with sandpaper. In yet further embodiments, the sanding attachment 40 may be spherical, conical, or have other shapes, and may include, additionally or alternatively, other structures, such as wire brushes, stone, and roughened metal, for abrading or wearing away materials, such as wood, metal, glass, and plastic. The motor 36 is disposed inside a housing 42, which is adapted to releasably seat within the harness 26 with the motor disposed under the top plate 28 and the sanding attachment 40 disposed above the top plate 28. In one embodiment, the housing 42 is generally cylindrical and the harness is complementarily shaped to receive the housing. In other embodiments, the housing 42 and harness 26 may have other complementary shapes or the harness may be adjustable to receive housings of different shapes.

The spindle sander 10 has an assembled condition and a disassembled condition. In the assembled condition, the lift assembly 14 is seated within the opening 24 such that the top plate 28 and the tabletop 20 are coextensive, and the drive unit 16 is seated in the harness 26 such that the motor 36 and housing 42 are disposed below the top plate and the sanding attachment 40 is disposed substantially above the top plate. In the assembled condition, the sanding attachment 40 is shifted vertically relative to the tabletop 20 by rotating the handle 30, which either raises or lowers the harness 26 and the drive unit 16, depending on the direction the handle is rotated. The vertical adjustability of the sanding attachment allows different portions of the sanding attachment to engage a work piece, which thereby allows the sanding attachment to be used uniformly and fully and minimize waste of unused sanding surface. The pin 32 stabilizes a work piece by limiting or helping control any sudden grabbing or pulling on a work piece that may occur when the work piece initially contacts the sanding attachment 40. The fence 22 may also be used to stabilize a work piece such that the spindle sander 10 may be used to sand straight edges on the work piece. The spindle sander 10 may be disassembled by removing the drive unit 16 from the lift assembly 14 and/or removing the lift assembly from the table 12. Locking assemblies (not shown) may be included to releasably lock the drive unit 16 into the lift assembly 14, and the lift assembly into the opening 24 in the table 12, so as to prevent unwanted disassembly of the spindle sander 10.

Another motorized tool 46, including a work attachment 48 extending from a motor and housing 50, such as, for example, a portable hand held router, flat grinding wheel, or a reciprocating saw, may also be used with the table 12. The housing 50 of the motorized tool 46 has an outer surface dimensional configuration, i.e., a form factor, that is substantially similar to or the same as the housing 42 of the drive unit 16 so that the motorized tool 46 may be carried by the harness 26 with the work attachment disposed above the top plate 28 and the motor housing disposed below the top plate, in a manner similar to the drive unit 16. In this manner, the table 12 and lift assembly 14 may be used alternatingly with multiple motorized tools, such as the drive unit 16 and the tool 46, and thereby save space in the workshop by only requiring one table 12 to accommodate and support multiple tools. In another embodiment, other attachments and accessories, such as clamps, miter guides, safety devices, etc., may also be secured to or used in conjunction with the table 12 such that the accessories may be used with the drive 16 and other tools that are adapted for use with the table. In yet another embodiment, a removable mounting plate that receives the drive unit 16 without providing any positional adjustability may replace the lift assembly 14 having the movable harness 24. In a further embodiment, no lift assembly 14 or removable mounting plate is used, and an opening through the table 12 is adapted to receive the drive unit 16 directly therein.

I claim:

1. A spindle sander comprising:
a body having a form factor; and
a work attachment;
wherein the form factor of the body is the same as a form factor of a portable router body that is adapted to be removably received in a harness carried by a work table.

2. The spindle sander of claim 1, wherein the spindle sander comprises an oscillating spindle sander.

3. A motorized tool kit comprising:
a first portable motorized tool having a first function and a body having a form factor;
a second portable motorized tool having a second function different from the first function and a second body having the same form factor; and
a table comprising a harness below a table top;
wherein the bodies of the first portable motorized tool and the second portable motorized tool are alternatingly releasably operatively mountable within the harness with a work attachment positioned to engage a work piece disposed on top of the table top.

4. The motorized tool kit of claim 3, wherein the first portable motorized tool comprises an oscillating spindle sander.

5. The motorized tool kit of claim 4, wherein the second portable motorized tool comprises a router.

6. The motorized tool kit of claim 5, wherein the table further comprises a lift assembly connected to the harness, and wherein the harness and the lift assembly are releasably mounted to a table.

7. The motorized tool kit of claim 6, wherein the table further comprises an adjustable guide means for guiding a work piece.

8. A support table for a portable motorized tool comprising:
a harness that is adapted to alternatingly receive a spindle sander drive unit and a second tool drive unit;
wherein the spindle sander drive unit has a form factor and the second tool drive unit has the same form factor; and
wherein each drive unit includes a work attachment that is disposed substantially above a working surface of the table and a motor that is disposed substantially below the working surface when the respective drive unit is operatively received in the harness.

9. The support table of claim 8, wherein the second tool is a router.

10. The support table of claim 9, wherein the support table further comprises a lift assembly that shiftably carries the harness.

11. The support table of claim 10 and further comprising guide means for guiding a work piece disposed on the support table.

12. The support table of claim 10 and further comprising guide means for guiding a work piece disposed on the harness.

13. The support table of claim 8, wherein the spindle sander drive unit comprises an oscillating spindle sander drive.

14. The support table of claim 8, wherein the spindle sander drive unit is a portable hand held drive unit.
